(19) United States
(12) Patent Application Publication
(10) Pub. No.: US 2010/0045216 A1
(43) Pub. Date: Feb. 25, 2010

(54) REDUCTION OF START-UP SEQUENCE

(75) Inventors: Rune Thomsen, Loegumkloster (DK); Niels Pedersen, Toender (DK)

Correspondence Address: MCCORMICK, PAULDING & HUBER LLP, CITY PLACE II, 185 ASYLUM STREET, HARTFORD, CT, 06103, US

(73) Assignee: DANFOSS COMPRESSORS GMBH, Flensburg (DE)

(21) Appl. No.: 12/544,257

(22) Filed: Aug. 20, 2009

(30) Foreign Application Priority Data
Aug. 22, 2008 (DK) 2008 01149

(51) Int. Cl. H02P 6/20

(52) U.S. Cl. 318/139; 318/400.11

(57) ABSTRACT

The present invention relates to a method for bringing a brushless motor, such as a multiphase brushless motor, operatively connected to for example a compressor into an optimal angular starting position in an energy saving manner, the method comprising the steps of applying a first drive voltage to a first phase winding of the motor and measuring a current flowing in another phase winding of said motor, said current being generated in response to the first drive voltage applied to the first phase winding. The method further comprises the step of switching the applied first drive voltage off when said current reaches a steady-state condition. By applying the method of the present invention a significant amount of power can be saved. The present invention further relates to a system for carrying out the present invention.

### CROSS REFERENCE TO RELATED APPLICATION

Applicant hereby claims foreign priority benefits under U.S.C. §119 from Danish Patent Application No. 2008 01149 filed on Aug. 22, 2008, the contents of which are incorporated by reference herein.

### FIELD OF THE INVENTION

The present invention relates to a method for bringing a brushless motor, such as a multiphase brushless motor, operatively connected to for example a compressor, into an optimal angular starting position in an energy saving manner. Moreover, the present invention relates to a system for carrying out the present invention.

### BACKGROUND OF THE INVENTION

Starting a cooling compressor can be a difficult task because the torque required to turn the compressor, and thus the rotor of a multiphase brushless motor operatively connected to the compressor, is very much dependent upon the position of the compressor in its compression cycle. It is therefore important that the rotor is placed in an optimal angular position in order for it to gain sufficient momentum to get over a peak torque on starting.

A method for starting multiphase brushless motor operatively connected to a compressor is discussed in U.S. Pat. No. 5,206,567.

In U.S. Pat. No. 5,206,567 the positions of the magnetic poles of the rotor are detected by monitoring the back electromotive force produced in each motor coil. According to U.S. Pat. No. 5,206,567 a sequence of alignment steps is used where a voltage is provided to one winding causing current to flow through it and out through the other two windings. This will turn the rotor to a particular position. When the rotor is stationary in this new position, the next positioning step is made, where a second winding is powered in the same way. Again, current flows through the winding and out through the other two windings. This second step is followed by a third and similar step. The sequence ensures that at least by the end of the third step the rotor is in a position from which it can accelerate enough to overcome the maximum torque.

It is a disadvantage of the method suggested in U.S. Pat. No. 5,206,567 that a relatively large amount of electrical power is injected into the motor during the starting process. This power is not necessarily used in supplying compressed gas to downstream systems and therefore can result in high power losses. Such losses are critical, particularly in battery-powered systems.

It is a further disadvantage of U.S. Pat. No. 5,206,567 that the generated back electromotive force signals are extremely small due to the limited speed and the restricted movement of the rotor during the above-mentioned start-up sequence. The limited speed and the restricted movement of the rotor result in a low S/N ratio which limits the accuracy of the measurements of the rotor movements. Thus, the starting sequence is likely to be extended to ensure that the rotor has actually stopped. The extended starting sequence is a major disadvantage from a power consumption point of view.

It may be seen as an object of the present invention to provide an effective and power saving method for bringing a multiphase brushless motor operatively connected to a compressor into a desired angular starting position so that the motor can accelerate enough to overcome the peak torque of a compressor cycle.

### SUMMARY OF THE INVENTION

The above-mentioned object is complied with by providing, in a first aspect, a method for efficiently bringing a rotor of a multiphase motor into a desired angular starting position, the method comprising the steps of
applying a first drive voltage to a first phase winding of the motor,
measuring a current flowing in another phase winding of said motor, said current being generated in response to the first drive voltage applied to the first phase winding, and
switching the applied first drive voltage off when said current reaches a steady-state condition.

The motor may be a multiphase brushless motor operatively connected to a compressor. As stated previously and as discussed in further details in the following the motor needs to be brought into an optimal angular starting position so that the motor can accelerate enough to overcome the peak torque of a compressor cycle.

It should be noted that the present invention is not limited to compressor-relates applications. Thus, the present invention is applicable within a broad range of motor-driven applications.

In the case that the motor has a second phase winding, the method may further comprise the steps of
applying a second drive voltage to a second phase winding of the motor,
measuring a current flowing in another phase winding of said motor, said current being generated in response to the second drive voltage applied to the second phase winding, and
switching the applied second drive voltage off when said current reaches a steady-state condition.

Similarly, in the case that the motor has a third phase winding, the method may further comprise the steps of
applying a third drive voltage to a third phase winding of the motor,
measuring a current flowing in another phase winding of said motor, said current being generated in response to the third drive voltage applied to the third phase winding, and
switching the applied third drive voltage off when said current reaches a steady-state condition.

The applied first, second and third drive voltages may comprise pulse width modulated (PWM) based drive voltages having a frequency from just a few kHz to potentially several hundred kHz. For compressor applications a frequency in the range 3-8 kHz, such as in the range 4-7 kHz, such as in the range 5-6 kHz, such as approximately 5.5 kHz may be applicable. Alternatively, the applied first, second and third drive voltage modulation may have a higher frequency such as a frequency in the range 8-30 kHz, such as in the range 10-25 kHz, such as in the range 15-22 kHz, such as approximately 20 kHz.

Optionally, the applied first, second and third drive voltages may comprise filtered PWM-based drive voltages. Filtered PWM-based drive voltages may be provided by passing PWM-based drive voltages through for example band-pass filters being matched to the switching frequency of the drive voltages. Alternatively, voltages representing the measured currents may be appropriately filtered before further processing. An appropriate way of filtering such voltages may involve band-pass or low-pass filtering.

The choice of criterion for deciding when a steady-state current conditions have been reached may depend upon several factors which depend in turn on the apparatus which the motor is connected to, and to the specific application which it is used for. Steady-state current conditions may be considered reached when variations in the current amplitude lie within a certain percentage of a steady state current, such as within 3% of half the total current through the motor. The choice of such a percentage may be governed by how close to a steady-state conditions it is wished that the motor has reached before proceeding in the start sequence. If a low percentage is chosen, then the motor will be closer to steady state conditions before proceeding in the start sequence than if a larger percentage is chosen.

The first, second and third drive voltages may in principle have arbitrary amplitudes, such as from a few volts to several hundred volts. The present invention is particularly suitable for low voltage/high current applications. An example of such a low voltage/high current application is a battery driven application. The voltage amplitudes of for example vehicle-related battery driven applications are typically in the range 10-30 V, such as within the ranges 10-14 V or 22-26 V.

In a second aspect, the present invention relates to a system for efficiently bringing a rotor of a multiphase motor into a desired angular starting position, the system comprising
means for generating a drive voltage to be applied to a phase winding of the motor,
means for measuring a current flowing in another phase winding of said motor in response to the drive voltage, and
means for determining when said current reaches a steady-state condition.

As previous stated the motor may be a multiphase brushless motor operatively connected to a compressor.

The means for generating the drive voltage may be adapted to generate a PWM-based drive voltage. Moreover, filter means for filtering the PWM-based drive voltage prior to applying the drive voltage to the phase winding may be provided. Alternatively, filter means for filtering a voltage representing the measured current may be provided. Such filter means may comprise a band-pass or a low-pass filter having an appropriate centre frequency or cut-off frequency, respectively.

### BRIEF DESCRIPTION OF THE DRAWINGS

The present invention will now be explained in further details with reference to the accompanying figures, wherein

FIG. 1 shows a system for carrying out the present invention,

FIG. 2 depicts torque versus angular rotor position in a compressor application,

FIG. 3 shows an applied first PWM-based drive voltage and associated currents in other phase windings,

FIG. 4 shows an applied second PWM-based drive voltage and associated currents in other phase windings,

FIG. 5 shows an applied third PWM-based drive voltage and associated currents in other phase windings,

FIG. 6 shows the principle underlying the present invention,

FIG. 7 shows a flow chart illustrating a first embodiment of the present invention, and

FIG. 8 shows a flow chart illustrating a second embodiment of the present invention.

### DETAILED DESCRIPTION OF THE INVENTION

In its broadest aspect the present invention relates to a method for bringing a multiphase brushless motor operatively connected to a compressor into a desired angular starting position in an effective and power saving manner. The principle underlying the present invention is to apply, in a sequential manner, drive voltages to the respective phase windings of the multiphase brushless motor and, at the same time, reduce the duration of each drive voltage to an absolute minimum. This is achieved by measuring the currents in two unpowered phase windings of the rotor. When these currents reach steady-state conditions the rotor of the brushless motor is stabilised. Thus, in contrast to known methods, which apply a fixed and predetermined time period, the present invention is concerned with waiting just until the rotor is stabilised before powering the next phase winding of the motor. By applying the method of the present invention the total time required to bring the multiphase brushless into the desired angular starting position is significantly reduced, and hence saves a significant amount of power. The latter is of particular importance in battery driven applications. Moreover, the method according to the present invention will minimise the component stress associated with the drive system and minimise the mechanical stress on the compressor. It is believed that the method of the present invention can be applied whenever a sensorless motor start-up algorithm is used.

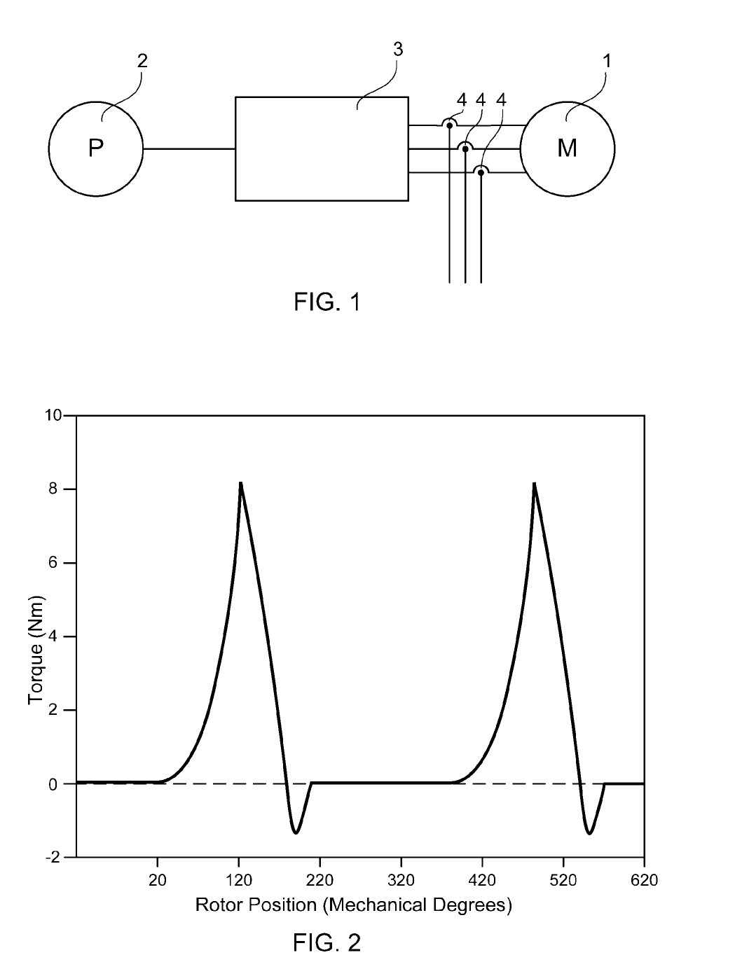

Referring now to FIG. 1 a system for carrying out the present invention on an associated motor/compressor 1 is depicted. As seen, the system comprises a power source 2, such as a battery, a drive system 3 and currents sensors 4 for measuring the phase currents provided to the phase windings of the motor 1. Typically the power source 2 involves a battery having a nominal battery voltage in the range 10-30 V. However, other voltage ranges may also be applicable. The drive system 3 preferably involves a multiphase modulator for generating a PWM drive voltage to each of the phase windings of the motor 1. The switching frequency of the PWM drive voltages can be chosen to fulfil specific system demands. For compressor applications a PWM switching frequency of around 5.5 kHz can advantageously be used. As depicted in FIG. 1 current sensors for measuring currents in each motor phase winding are provided. These current sensors can be of any suitable type. Moreover, electronic filters (not shown in FIG. 1), such as band-pass filters, may advantageously be provided for filtering the PWM drive voltages from the drive system 3. The centre frequency of such band-pass filters should preferably match the switching frequency of the drive system 3. Alternatively, low-pass filters having appropriate cut-off frequencies can be applied.

Alternatively, band-pass or low-pass filters for filtering a voltage representing the measured currents may be applied.

Referring now to FIG. 2 the required torque versus the angular rotor position for a compressor application is depicted. As seen the required motor torque peaks once for every 360 degrees rotor cycle. In order to overcome the peak torque during start-up the motor needs to gain sufficient momentum. Referring to the full rotor cycle between 220 and 600 degrees the motor should preferably be positioned near the 220 degrees mark prior to being started in order to gain the required momentum.

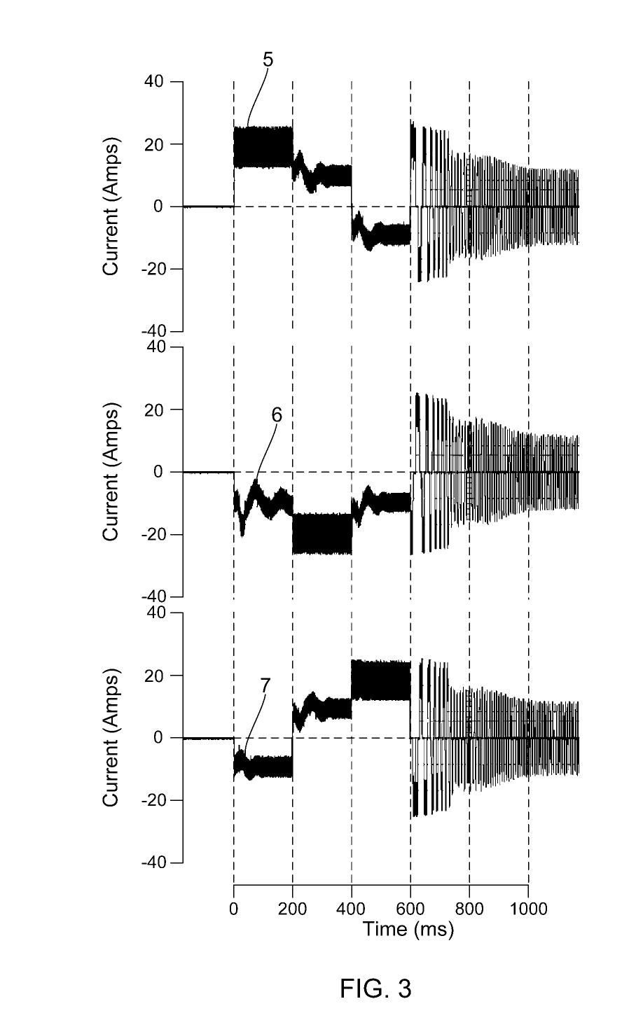

Referring now to FIG. 3 a first PWM drive voltage 5 has been applied to one out of three phase winding. The duration of the first PWM drive voltage is 200 ms and its mean amplitude is around 20 A. It should be noted that the duration of the PWM drive voltage and its mean amplitude may differ significantly from these values.

The oscillating behaviour of the first PWM drive voltage is due to the PWM nature of the first drive voltage. The PWM switching frequency is 5.5 kHz. During the appliance of the first PWM drive voltage 5 currents 6, 7 flowing in the two other phase windings are measured. As seen in FIG. 3 the currents 6, 7 oscillate with the PWM switching frequency over the full period of 200 ms. On top of the high frequency oscillation the currents 6, 7 also exhibit a damped oscillating behaviour with a much lower frequency. The damped oscillating behaviour originates from rotor vibrations which die out after about 100 ms when the rotor is stabilised in a new position.

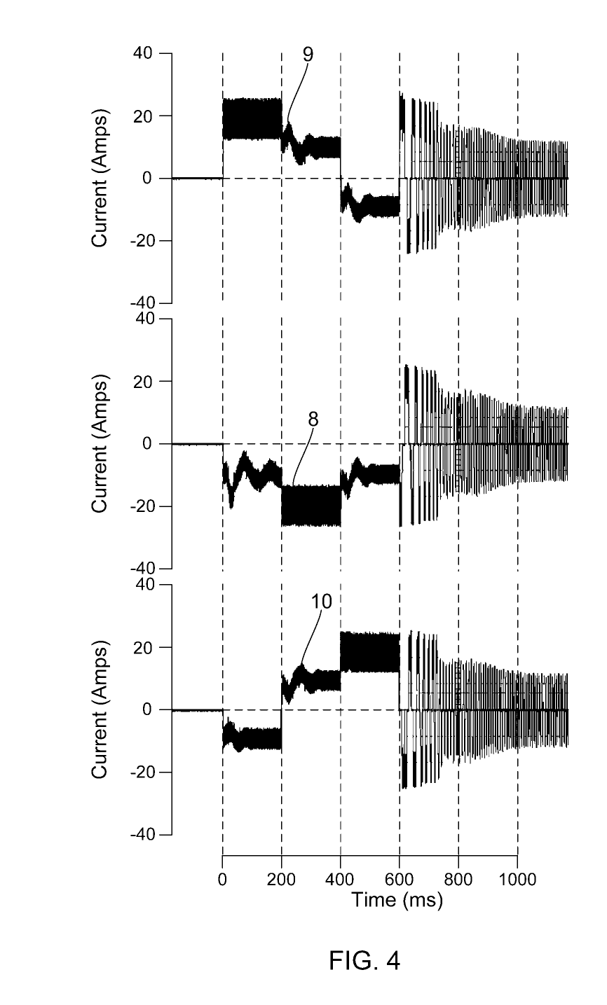

FIG. 4 depicts a second PWM drive voltage 8 and associated current 9, 10 measured in the other two windings of the motor. Again, the duration of the second PWM drive voltage is 200 ms, its mean amplitude is around 20 A and the PWM switching frequency is 5.5 kHz. Again, the currents 9, 10 exhibit a damped oscillating behaviour due to rotor vibrations. The rotor vibration induced oscillations die out after about 100 ms, i.e. when the rotor has stabilised in a new position.

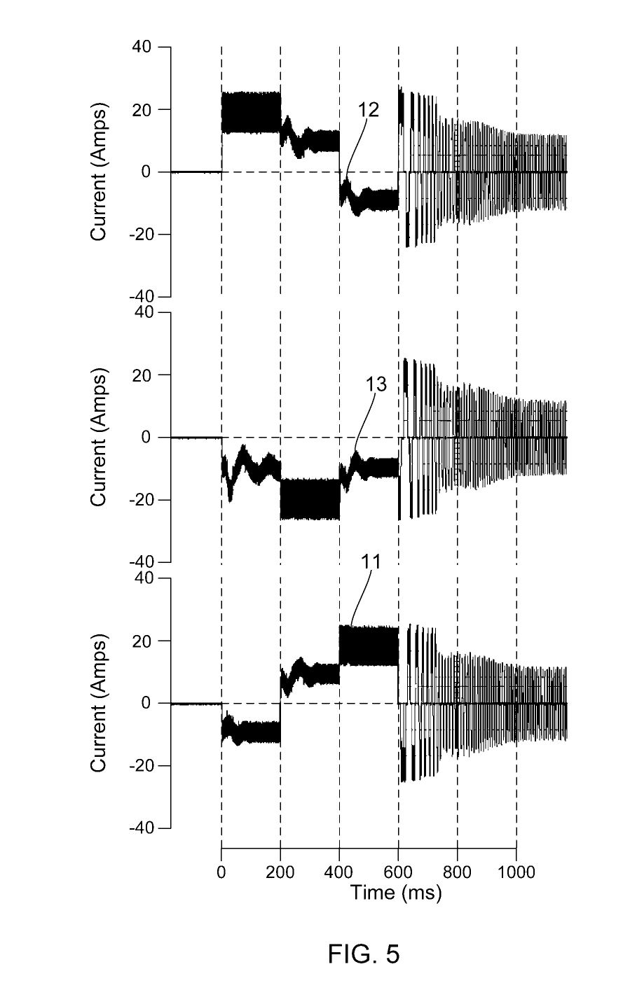

FIG. 5 depicts a third PWM drive voltage 11 and associated current 12, 13 measured in the other two windings of the motor. As previously, the duration of the third PWM drive voltage is 200 ms, its mean amplitude is around 20 A and the PWM switching frequency is 5.5 kHz. The currents 12, 13 exhibit a damped oscillating behaviour due to rotor vibrations. The rotor vibration induced oscillations die out after about 100 ms, i.e. when the rotor has stabilised in a new position.

From the illustrations shown in FIGS. 3-5 it is clear that a significant amount of power can be saved if the duration of the PWM drive voltages are shortened. Thus, instead of applying a fixed duration of 200 ms, the duration of the PWM drive voltage can be shortened by only applying the PWM drive voltages as long as the currents 6, 7 and 9, 10 and 12, 13 oscillate, i.e. as long as the rotor vibrates. As soon as the rotor has stabilised in a new position the PWM drive voltage in question is switched off.

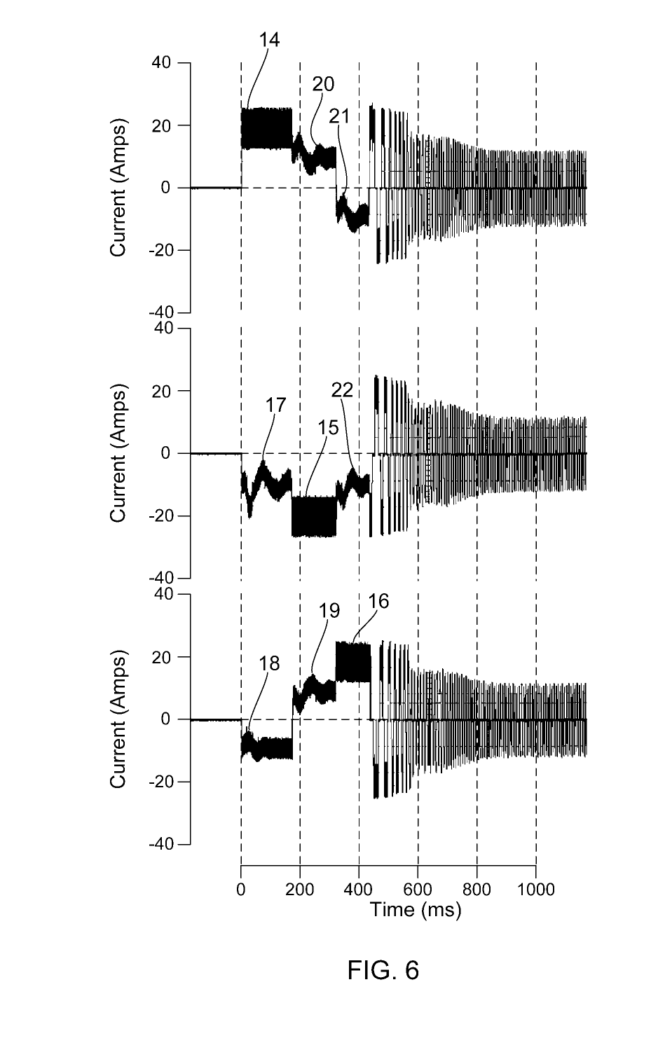

Thus, as depicted in FIG. 6 the PWM drive voltages 14, 15, 16 are only applied as long as their associated currents exhibit dynamic behaviours. This means that when the currents 17, 18 enter a steady-state condition the PWM drive voltage 14 is switched off and the PWM drive voltage 15 is switched on. When the currents 19, 20 enter a steady-state condition the PWM drive voltage 15 is switched off and the PWM drive voltage 16 is switched on. When the currents 21, 22 enter a steady-state condition the PWM drive voltage 16 is switched off and the starting sequence of the present invention has been completed. By applying the starting sequence of the present invention a significant amount of power can be saved, since the starting sequence of the present invention involves the supply of power to the motor for a significantly reduced time period. From FIG. 6 it can be deduced that the required power to complete the starting sequence can be reduced to about half of that required in prior art starting sequences.

It should be noted that it is not necessary to measure all three motor phase currents. In general only two motor phase currents are required. The third motor phase current can be calculated using Kirchoff's current law. Moreover, the measured motor current signals may optionally be filtered, such as band-pass filtered, in order to suppress switch noise.

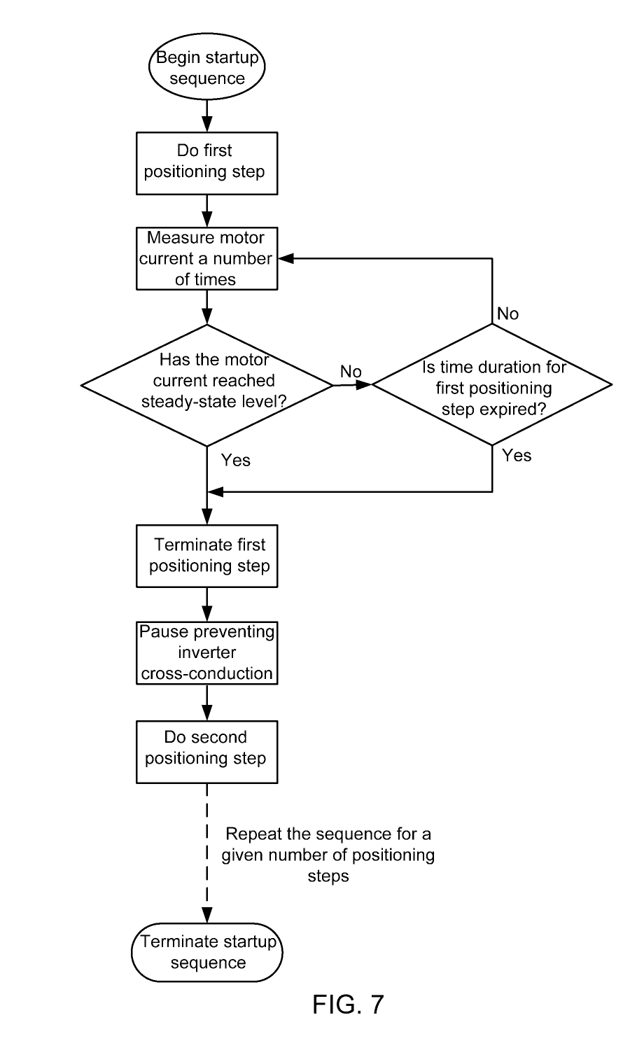

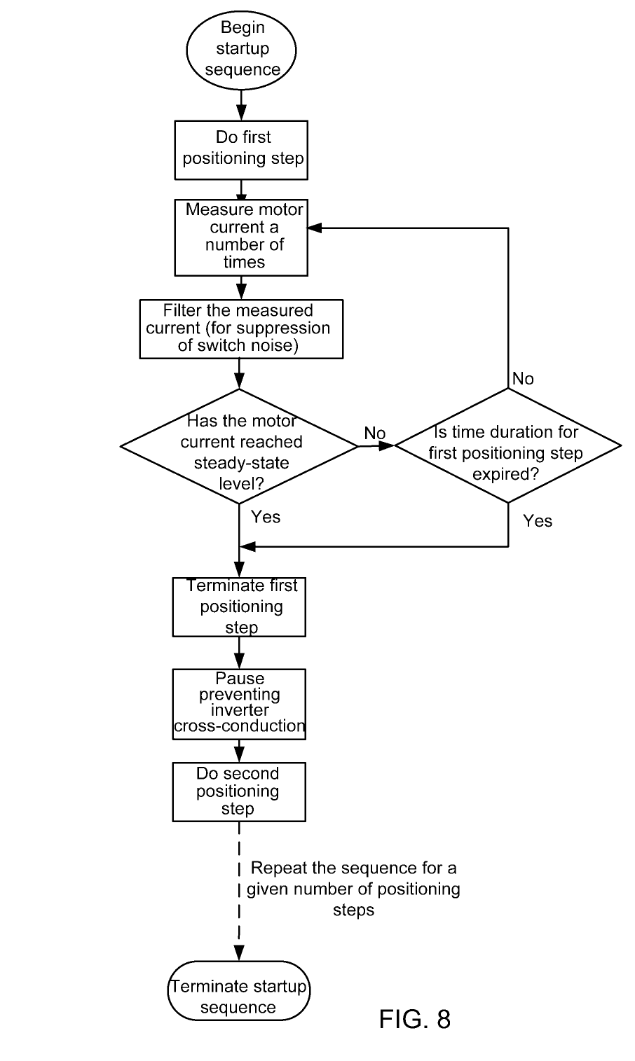

FIGS. 7 and 8 both illustrate the starting sequence of the present invention in the form of flow charts.

Referring to the flow chart of FIG. 7 the first positioning step, which involves the appliance of a PWM drive voltage, also involves measuring of phase currents an appropriate number of times. The choice of the number of times will be governed by several factors such as the processing power available, the resolution of the current measuring system and the expected time period that a positioning step will take. At least one measurement should be made, but it is preferable that several, such as 10 measurements or 100 measurements, should be made.

The determination of whether the phase currents have reached steady state conditions can be made by determining if the oscillations of the phase currents are less that a certain amplitude, or if the amplitudes of the phase currents are within certain limits (such as within 3% of half the total current through the motor phase windings) over several measurements If it is determined that the phase currents have reached steady-state conditions, the first positioning step is terminated by switching off the applied PWM drive voltage. Before initiating the second positioning step, a pause is introduced in order to avoid cross-conduction in the phase windings of the motor.

In the case that the phase currents have not reached steady-state conditions it has to be determined if the maximum allowed time for performing the first positioning step has expired. The maximum allowed time is dependent on mechanical constants within the system. For example, such a maximum allowed time might lie in the interval 60 ms-300 ms for a single positioning step for a motor controlling a compressor, such as a household compressor. If the maximum allowed time has been reached, or has already been exceeded, the first positioning step is terminated. If the maximum allowed time has not been reached the phase currents are measured a number of times in order to determine if steady-state conditions have been reached. If steady-state conditions have been reached the first positioning step is terminated, if not, an additional iteration is performed.

Preferably, the above-mentioned positioning step is repeated for each of the available phase windings of the motor. Thus, if the motor has three phase windings, the starting sequence involves three steps in order to bring the motor to the desired position.

FIG. 8 shows a flow chart similar to FIG. 7 except for the fact that the measured current signals are filtered in order to suppress switch noise.

While the invention is susceptible to various modifications and alternative forms, specific embodiments have been shown by way of example in the figures and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

What is claimed is:

1. A method for efficiently bringing a rotor of a multiphase motor into a desired angular starting position, the method comprising the steps of:
applying a first drive voltage to a first phase winding of the motor,
measuring a current flowing in another phase winding of said motor, said current being generated in response to the first drive voltage applied to the first phase winding, and
switching the applied first drive voltage off when said current reaches a steady-state condition.

2. The method according to claim 1, further comprising the steps of:
applying a second drive voltage to a second phase winding of the motor,
measuring a current flowing in another phase winding of said motor, said current being generated in response to the second drive voltage applied to the second phase winding, and
switching the applied second drive voltage off when said current reaches a steady-state condition.

3. The method according to claim 2, further comprising the steps of:
applying a third drive voltage to a third phase winding of the motor,
measuring a current flowing in another phase winding of said motor, said current being generated in response to the third drive voltage applied to the third phase winding, and
switching the applied third drive voltage off when said current reaches a steady-state condition.

4. The method according to claim 1, wherein steady-state current conditions are considered reached when the oscillations in the current amplitude remain within +/−3% of the total motor current divided by the number of undriven phases.

5. The method according to claim 1, wherein the first, second and third drive voltages have amplitudes in the range 10-30 V, such as within the ranges 10-14 V or 22-26 V.

6. The method according to claim 1, wherein the first, second and third drive voltages are provided from a battery.

7. A system for efficiently bringing a rotor of a multiphase motor into a desired angular starting position, the system comprising:
means for generating a drive voltage to be applied to a phase winding of the motor,
means for measuring a current flowing in another phase winding of said motor in response to the drive voltage, and
means for determining when said current reaches a steady-state condition.

8. The system according to claim 7, further comprising filter means for filtering a voltage representing a measured current.

9. The system according to claim 8, the filter means comprises a low-pass filter.

10. The system according to claim 7, wherein the drive voltage has an amplitude in the range 10-30 V, such as within the ranges 10-14 V or 22-26 V.

11. The system according to claim 7, further comprising a battery adapted to provide the drive voltage.
